(19) United States
(12) Patent Application Publication
(10) Pub. No.: US 2026/0167363 A1
(43) Pub. Date: Jun. 18, 2026

(54) DEVICES, SYSTEMS, AND PROCESSES FOR WATER COLLECTION AND FILTRATION

(71) Applicant: Fremen Space, Inc., Ithaca, NY (US)

(72) Inventor: Sofia Mellone Etlin, Ithaca, NY (US)

(21) Appl. No.: 19/533,538

(22) Filed: Feb. 9, 2026

Related U.S. Application Data
(63) Continuation of application No. PCT/US24/41783, filed on Aug. 9, 2024.
(60) Provisional application No. 63/532,112, filed on Aug. 11, 2023.

(51) Int. Cl. B64G 6/00; C02F 1/28; C02F 1/44; C02F 9/20; C02F 103/00

(52) U.S. Cl. CPC B64G 6/00; C02F 9/20; C02F 1/283; C02F 1/441; C02F 1/445; C02F 2103/005; C02F 2201/001

(57) ABSTRACT

Disclosed herein are devices, systems, and processes for providing water collection and filtration of user wastewater for return as potable drinking water. Systems described include ones with a plurality of layers having a top layer with water permeable fabric, a first middle layer with an antimicrobial material, a second middle layer with activated carbon, a bottom layer having a water impermeable material, an osmotic filter configured to filter the collected bodily fluid from the bodily fluid collection system; and a mechanical device configured to move the filtered fluid from the osmotic filter.

### CROSS-REFERENCE TO RELATED APPLICATIONS

This application claims the benefit of priority and is a continuation of International Application No. PCT/US2024/041783, filed Aug. 9, 2024, which claims priority under 35 U.S.C. § 119 from U.S. Provisional Application No. 63/532,112 filed on Aug. 11, 2023, the disclosures of which are incorporated herein by reference in their entirety.

### BACKGROUND

During space travel, astronauts require sophisticated life support systems, such as extravehicular mobility units (EMUs) to adapt to their changing needs. During extravehicular activities (EVAs), astronauts may spend a total time exceeding 12 hours in the EMUs, thus requiring systems that allow for them to urinate and defecate while both increasing work efficiency and minimizing potential health concerns. Additionally, there are no systems for recycling water within spacesuits, and the cost of sending enough water to sustain astronauts during space travel is exorbitant. Thus, there is a need for improved methods and systems for increasing available drinking water while ensuring comfortable and hygienic conditions for the astronaut.

### BRIEF SUMMARY

The devices, systems, and processes provided herein are based, at least in part, on the concept of improved collecting and filtering of water and/or waste of a user of said device or system.

One aspect of the invention features a system including a bodily fluid collection system with a urine collection system and a feces collection system, the urine collection system having a top layer having a water permeable fabric; a first middle layer with an antimicrobial material; a second middle layer with activated carbon; and a bottom layer with a water impermeable material, an osmotic filter configured to filter the collected bodily fluid from the bodily fluid collection system, and a mechanical device configured to move the filtered fluid from the osmotic filter.

In some embodiments, the osmotic filter includes a forward osmosis module and a reverse osmosis module. In some embodiments, the osmotic filter includes a forward osmosis module, a vacuum chamber, and a condenser. In some embodiments, the osmotic filter includes at least one moveable barrier. In some embodiments, the mechanical device is a positive-displacement pump, a centrifugal pump, an axial-flow pump or a centrifugal fan. In some embodiments, the water permeable fabric includes polypropylene. In some embodiments, the water permeable fabric includes a non-woven or woven fabric. In some embodiments, the woven fabric is grade 40 plain unbleached cotton. In some embodiments, the activated carbon is a powder, granulated, pelletized, beaded, impregnated, polymer coated, woven, extruded, or combinations thereof. In some embodiments, the activated carbon is granulated. In some embodiments, the antimicrobial material further includes an antimicrobial polymer or an inorganic particle. In some embodiments, the antimicrobial polymer is chitosan or poly-ε-lysine. In some embodiments, the inorganic particle includes silver, copper, or titanium dioxide. In some embodiments, the water impermeable material includes silicone. In some embodiments, the urine collection system and the feces collection system are separated by a divider configured to be adjacent to a user's perineum. In some embodiments, the feces collection system further includes a carbon-sequestering bacteria. In some embodiments, the carbon-sequestering bacteria includes a purple phototrophic bacteria (PPB).

Another aspect of the invention features a method including collecting a bodily fluid via a bodily fluid collection system, the bodily fluid collection system including a top layer with a water permeable fabric; a first middle layer with an antimicrobial material; a second middle layer of granular activated carbon; and a bottom layer with a water impermeable fabric; filtering, via an osmotic filter, the collected bodily fluid from the bodily fluid collection system; and moving, via a mechanical device, the filtered fluid from the osmotic filter.

In some embodiments, the osmotic filter includes a forward osmosis filter and a reverse osmosis filter. In some embodiments, the osmotic filter includes a forward osmosis module, a vacuum chamber, and a condenser. In some embodiments, the osmotic filter includes at least one moveable barrier. In some embodiments, the mechanical device is a positive-displacement pump, a centrifugal pump, an axial-flow pump. or a centrifugal fan. In some embodiments, the activated carbon is a powder, granulated, pelletized, beaded, impregnated, polymer coated, woven, extruded, or combinations thereof. In some embodiments, the activated carbon is granulated. In some embodiments, the antimicrobial material further includes an antimicrobial polymer or an inorganic particle. In some embodiments, the antimicrobial polymer is chitosan or poly-ε-lysine. In some embodiments, the inorganic particle includes silver or copper. In some embodiments, the water impermeable material includes silicone.

One aspect of the invention features a method including filtering and collecting a fluid via at least one semi-permeable tube, wherein the at least one semi-permeable tube is connected to a container; sending, via a mechanical device, the collected fluid from the at least one semi-permeable tube to an absorber radiator; and condensing and absorbing the collected fluid on the absorber radiator, thereby generating heat which radiates to a space outside of the container and the absorber radiator.

In some embodiments, the container is an in-suit drink bag. In some embodiments, the mechanical device is a positive-displacement pump, a centrifugal pump, or an axial-flow pump. In some embodiments, the at least one semi-permeable tube includes polytetrafluoroethylene. In some embodiments, the absorber radiator is a lithium chloride absorber radiator.

Another aspect of the invention features a system including a bodily fluid collection system with a plurality of layers, wherein the bodily fluid collection system is configured to collect bodily fluid; an osmotic filter configured to process the collected bodily fluid, thereby producing a filtered fluid; a mechanical device configured to move the bodily fluid from the bodily fluid collection system through the osmotic filter; and at least one sensor configured to measure the filtered fluid and/or the collected bodily fluid, wherein the sensor detects and provides an alert if at least one of the following thresholds is exceeded: less than 85% bodily fluid collection rate in the bodily fluid collection system; less than 75% filtered fluid recovery from the osmotic filter; greater than 250 ppm of NaCl in the filtered fluid; or greater than 10 ppm of urine solutes in the filtered fluid.

In some embodiments, the osmotic filter includes a forward osmosis filter and a reverse osmosis filter. In some embodiments, the osmotic filter includes a moveable barrier. In some embodiments, the mechanical device is a vacuum pump or a centrifugal fan. In some embodiments, the bodily fluid is urine, and wherein the mechanical device is configured to move the urine from the plurality of layers through the osmotic filter. In some embodiments, the plurality of layers includes water permeable fabric and/or flexible granular activated carbon.

One aspect of the invention features a spacesuit having any of the systems disclosed herein. Another aspect of the invention features an extravehicular mobility unit (EMU) including any of the systems disclosed herein.

One aspect of the invention features a method including collecting a bodily fluid in a bodily fluid collection system having a plurality of layers; filtering the collected bodily fluid with an osmotic filter; analyzing the filtered fluid; and triggering an alert if any one of the following thresholds are exceeded for the filtered fluid: less than 85% bodily fluid collection rate in the bodily fluid collection system; less than 75% filtered fluid recovery from the osmotic filter; greater than 250 ppm of NaCl in the filtered fluid; or greater than 10 ppm of urine solutes in the filtered fluid. In some embodiments, the bodily fluid is urine.

Another aspect of the invention features a system including a container configured to hold liquid; at least one semi-permeable tube configured to filter and collect a fluid, wherein the at least one semi-permeable tube is connected to the container; an absorber radiator connected to the at least one semi-permeable tube; and a mechanical device configured to send the collected fluid from the at least one semi-permeable tube to the absorber radiator, wherein the collected fluid condenses and is absorbed, thereby generating heat which radiates to a space outside the system.

In some embodiments, the container includes an in-suit drink bag and a means of extracting fluid therefrom. In some embodiments, the mechanical device is a circulating pump. In some embodiments, the system comprises a cooling water loop. In some embodiments, the at least one semi-permeable tube includes polytetrafluoroethylene. In some embodiments, the absorber radiator is a lithium chloride absorber radiator.

Provided herein are systems comprising a top layer comprising a water permeable fabric, a first middle layer comprising an antimicrobial material, a second middle layer comprising activated carbon, and a bottom layer comprising a water impermeable material, an osmotic filter configured to filter the collected bodily fluid from the bodily fluid collection system, and a mechanical device configured to move the filtered fluid from the osmotic filter. Further provided herein are systems wherein the osmotic filter comprises a forward osmosis module and a reverse osmosis module. Further provided herein are systems wherein the osmotic filter comprises a forward osmosis module, a vacuum chamber, and a condenser. Further provided herein are systems wherein the osmotic filter comprises at least one moveable barrier. Further provided herein are systems wherein the mechanical device is a positive-displacement pump, a centrifugal pump, an axial-flow pump. or a centrifugal fan. Further provided herein are systems wherein the activated carbon is a powder, granulated, pelletized, beaded, impregnated, polymer coated, woven, extruded, or combinations thereof. Further provided herein are systems wherein the activated carbon is granulated. Further provided herein are systems wherein the antimicrobial material further comprises an antimicrobial polymer or an inorganic particle. Further provided herein are systems wherein the antimicrobial polymer is chitosan or poly-ε-lysine. Further provided herein are systems wherein the inorganic particle comprises silver or copper. Further provided herein are systems wherein the water impermeable material comprises silicone.

### BRIEF DESCRIPTION OF THE DRAWINGS

The features of the disclosure are set forth with particularity in the appended claims. The patent or application file contains at least one drawing executed in color. Copies of this patent or patent application publication with color drawing(s) will be provided by the Office upon request and payment of the necessary fee. A better understanding of the features and advantages of the present disclosure will be obtained by reference to the following detailed description that sets forth illustrative embodiments, in which the principles of the disclosure are utilized, and the accompanying drawings of which:

FIGS. 1A-1B are schematics of exemplary extravehicular mobility unit (EMU) systems as described herein and compared to current units;

FIGS. 2A-2B are schematics of exemplary urine collection systems described herein for collecting urine and feces from a user;

FIG. 3 is a schematic of an exemplary gas loop for collecting water vapor emitted from a user;

FIGS. 4A-4B are illustrations showing exemplary water filtration systems;

FIG. 5 is a depiction of a current cooling water loop in an EMU; and

FIG. 6 is a plot showing water collection results over time of an exemplary EMU system.

### DETAILED DESCRIPTION

Provided herein are devices, systems and processes for providing water collection and filtration, wherein the water collection and filtration systems allow for absorbing and filtering user wastewater for return as drinking water. In some embodiments, the water collection and filtration systems described herein comprise: a bodily fluid collection module comprising a plurality of layers configured to collect bodily fluid; an osmotic filter module configured to process the collected bodily fluid for producing a filtered fluid; and a mechanical module configured to move the bodily fluid from the bodily fluid collection system through the osmotic filter. The combination of modules can be used for recycling water produced from the user's own body with increased comfort and hygiene, while further providing for multi-purpose part consolidation with minimal fouling and a higher water return.

Commonly described extravehicular mobility units (EMU) are generally developed for short-duration missions in low earth orbit, in which lack of resource recycling, frequent maintenance, and dependence on space stations are acceptable. Spacewalks—e.g., when an astronaut exits their space vehicle to perform an extravehicular activity (EVA) usually last between five and eight hours with the longest spacewalk on record, so far, lasting 8 hours and 56 minutes. Additionally, astronauts must spend 2 to 3 hours inside the suit during EVA preparation, airlock depressurization, and re-pressurization. In total, time spent in the EMU can exceed 12 hours.

The current state-of-the-art waste management system in the EMU is a large absorbent diaper, the Maximum Absorbency Garment (MAG), which astronauts urinate and defecate into throughout spacewalks. The MAG is then discarded into a capsule that is deployed and demises in the upper atmosphere. During an eight to twelve hour long spacewalk, an astronaut may urinate and defecate multiple times. For example, it is expected that astronauts would have about 7 urination and 2 defecation events per day, though the frequency of each may vary. Their waste is not managed or processed during the spacewalk, and sometimes for hours after in the case of a contingency scenario that prevents them from returning to the international space station (ISS).

Crew members have raised several concerns including odors that prevent the crew members from eating, contamination of the food system, GI distress, urinary tract infections (UTIs), skin rashes, and eye irritation. To avoid defecating in the EMU astronauts may eat reduced meals for several days beforehand, significantly reducing their performance during physically demanding EV As. These medical events negatively impact productivity, both during the spacewalk and after, which may require treatment and management of these varied issues with medication that imposes additional shipping costs, untenable in a large-scale lunar mission.

Additionally, in the commonly used EMU, sweat condenses into a liquid cooling and ventilation garment (LCVG), creating an unpleasant, humid environment that fosters pathogen growth and causes skin irritation, while also damaging the suit itself. The LCVG functions to remove excess body heat produced by the astronaut during spacewalks, keeping them at a comfortable temperature. Furthermore, the problem of dehydration is exacerbated via excessive sweating. The In-suit Drink Bag (IDB) in the current EMU, which provides water and a small amount of glucose to the astronauts during spacewalks, currently holds just 32 ounces (i.e., about 0.95 L) or, in some cases, 21 ounces of water. During the 2006 Apollo Summit, crewmembers strongly recommended that “237 ml (8 oz) of water per hour be available for consumption during a lunar EVA,” with water available for “contingency scenarios, such as a 10-km (6.2-mi) walk-back in case of rover failure.” Astronauts currently have over 4.5 times less water available for consumption than recommended, assuming an eight-hour-long spacewalk. Not only is this a very small amount of water for the current length of spacewalks, but NASA recognizes that the longer and more work-intensive EVAs that are likely to be planned for future exploration missions will need to account for astronaut nutrition and hydration. Specifically, dehydration is an issue that can lead to poor crew performance. To establish the first long-term presence on the moon in the coming decades there is urgent need for a system that provides additional drinking water.

EMUs generally benefit from further ensure isolation between the collection system and waste disposal system so as to avoid any accidental leakage or discharge of waste into undesirable regions of the suit. Such leakage may cause deterioration or malfunctioning of other systems in the suit—such as those for safety and operational effectiveness—or, if exposed to the user's skin, may result in a risk of skin irritation or mucous membrane damage. Users have previously reported about leakage in the MAG, where it was found difficult to distinguish between urine and sweat from the LCVG.

As per recent guidelines reflecting an increase in the required EVA hydration of approximately 240 mL per hour, the EMUs are now designed to accommodate a total urine volume (Vu) calculated by the formula Vu=0.5+(2.24t/24) L, where “t” represents the duration of the EVA in hours. Regardless of the length of time of the spacewalk, and at the minimum for extended contingency operation in spacewalks greater than 24 hours, the suits must be able to collect and contain up to 1 L of urine and 75 g in mass or 75 mL in volume of fecal matter per day for each crew member.

The IDB itself also presents significant issues to astronauts embarking on EV As. In the 2006 Apollo Summit astronauts requested that the time required to prepare the IDB prior to conducting an EVA be decreased, since filling and degassing the drink bag used in the current EMU is time-consuming and contributes to a poor work efficiency index (WEI) of shuttle and ISS EV As. The WEI for the average astronaut is roughly 0.39-0.5.

While many changes to EMUs must be implemented in order to achieve interplanetary colonization, the inventors have recognized and appreciated that adapting and integrating a water filtration loop in a cooling water loop would allow water from bodily fluids to be recycled into potable water and eliminate water loss from the Cooling Water Loop, eliminating further need for most external water sources. There is currently no system that recycles the water produced by the astronaut's own body through sweat and urine.

In view of the foregoing, there is a need for improved water collection and filtration systems for EMUs or other applications with greater water recycling capabilities while reducing health concerns of users. This disclosure relates generally to water collection and filtration systems for absorbing, filtering, and recycling user wastewater, and methods of operating thereof. In some embodiments, this disclosure provides water collection and filtration systems for integration with components of an EMU.

In particular, provided herein are (I) Integrated Extravehicular Mobility Units (EMUs) (II) bodily fluid collection systems; (III) water filtration systems; (IV) cooling water loops; and (V) waste management systems.

The examples presented herein are for the purpose of furthering an understanding of the invention. The examples are illustrative and the invention is not limited to the example embodiments. The methods of the present invention are useful for the development of water collection and filtration systems for space travel, healthcare, military settings, and emergency scenario mitigation in extended travel.

### I. Integrated Extravehicular Mobility Unit (emu)

The present disclosure provides devices and systems that overcome the limitations of existing EMUs by providing features of water collection and filtration systems to recycle water excreted by a user during use of the EMU and to make the recycled water available for drinking by the user.

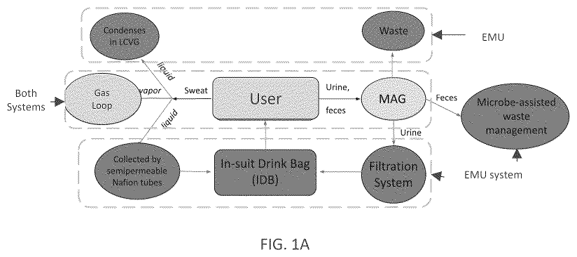

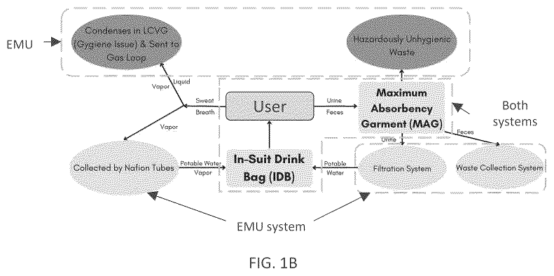

In some embodiments, an EMU system comprises an electronic module, an in-suit drink bag (IDB), a maximum absorbency garment (MAG), a bodily fluid collection system, a filtration system, a cooling water loop, and a waste management system. FIGS. 1A-1B illustrate exemplary EMU systems as compared to the current systems. In some embodiments, the EMU is designed to achieve a filtration rate from 100 mL to 4 L every 2-4 hours, which is then provided to the user as drinking water, so as to increase crew member autonomy in maintaining their own comfort and/or health while reducing or altogether removing the need of outside medical intervention. In some embodiments, the EMU is designed to achieve a filtration rate from 500 mL to 2 L every 2-4 hours. In some embodiments, the EMU is designed to achieve a filtration rate of about 1 L every 2-4 hours. FIG. 1A also shows a gas loop for collecting water vapor emitted from the user, which is described in more detail below.

The electronics module may also be referred herein as the primarily life support system (PLSS). In some embodiments, the electronics module includes, but is not limited to, a printed circuit board assembly (PCBA) that houses and electrically interfaces many of the components of the EMU system including, but not limited to, integrated circuits (ICs), at least one microcontroller (MCU) (with a processor, memory and input/output peripherals), a network adapter and a plurality of sensors. Some of the functions of the electronics module in conjunction with a firmware each of the components of the EMU system include, but are not limited to, turning the components on/off; recognizing user input; processing data; storing data; managing power supply; sending and receiving data; and pairing/unpairing to an external device/application via a wired or wireless communication. In some embodiments, the EMU system is configured to operate at no more than 10% additional energy cost than current EMU systems. In some embodiments, the electronics module further comprises a display screen, such as an LCD screen, to display any information associated with the EMU.

In some embodiments, the electronics module comprises a power supply. In some embodiments, the power supply comprises a battery. In some embodiments, the battery provides from 10 to 100 ampere hours. In some embodiments, the battery provides from 20 to 50 ampere hours. In some embodiments, the battery provides from 25 to 30 ampere hours. In some embodiments, the battery provides about 26.6 ampere hours. In some embodiments, the battery operates at a voltage range from 10 to 30 volts. In some embodiments, the battery operates at a voltage range from 15 to 25 volts. In some embodiments, the battery operates at a voltage range from 17.5 to 20.6 volts. In some embodiments, the battery operates at about 16.8 volts. In some embodiments, the plurality of sensors comprises a humidity sensor, as provided in the urine collection system described in more detail below. In some embodiments, the plurality of sensors comprises a plurality of sensors designated for a diagnostic function. In some embodiments, the plurality of sensors measures gas levels within the gas lines or within the suit. For example, the levels of CO₂, H₂O, N₂, ammonia, CO, sulfur gases, methane, or combinations thereof are monitored and reported to the user and/or a monitoring system. In some embodiments, the plurality of sensors measures analytes in a user's urine, sweat, and/or filtered water. For example, the levels of urea, ammonia, creatinine, bacteria, protein, NaCl, or combinations thereof are monitored and reported to the user and/or a monitoring system.

For the current state-of-the-art EMUs, the in-suit drink bag (IDB) is a heat-sealed, flexible container made of polyurethane film with a 32 fluid oz carrying capacity. In some embodiments, the IDB provided herein comprises a bag and a straw, wherein the bag is configured to wrap behind a user's neck. In some embodiments, the bag comprises a capacity from 500 mL to 4 L of water. In some embodiments, the bag comprises a capacity from 1 L to 3 L of water. In some embodiments, the bag comprises a capacity of about 2 L of water. This volume considers the looping nature of emiction production and water consumption by a user. Water (e.g., from breath, humidity condensate, and urine) collected from a bodily fluid collection system is filtered and routed to the IDB for access to the user.

In some embodiments, the Maximum Absorption Garment (MAG) is in fluid communication with the bodily fluid collection system, the filtration system, and the waste management system. The waste management system may also be referred herein as the waste collection system or the microbe-assisted waste management system. The MAG comprises a large, absorbent garment for collecting urine and feces from the user, wherein the MAG is adapted for disposal after use. The urine is diverted to a urine collection system, wherein the feces are diverted to a feces collection system within a waste management system.

### II. Bodily Fluid Collection Systems

Provided herein is a bodily fluid collection system for downstream integration with a filtration system. In some embodiments, the bodily fluid collection system comprises a urine collection system (UCS), a gas loop, and a humidity condensate collection system. The UCS is configured to be capable of at least 85% urine collection rate. In some embodiments, the UCS collects 85%, 90%, 95%, 98% or more fluid (v/v) during an elimination period.

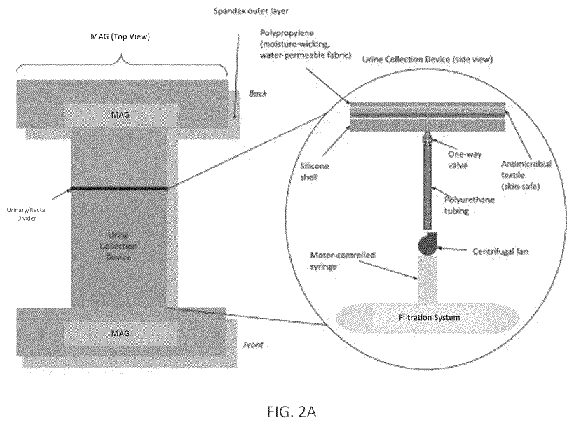

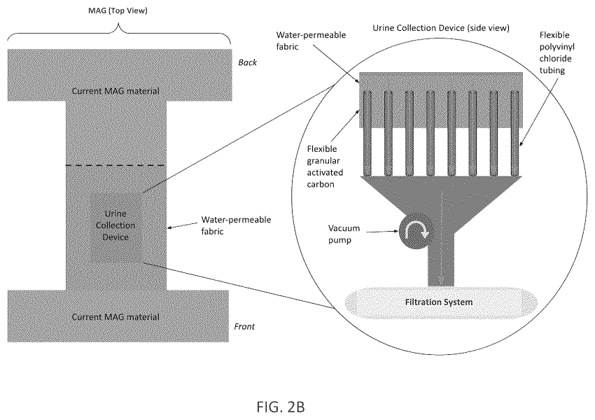

In some embodiments, the UCS comprises a plurality of layers, the plurality of layers comprising: a top layer comprising a water permeable fabric; a first middle layer comprising an antimicrobial material; a second middle layer comprising activated carbon; and a bottom layer comprising a water impermeable material. FIGS. 2A-2B illustrate exemplary embodiments of UCSs provided herein. After each use, each of the top layer, the first middle layer, and the second middle layer may be disposed to maintain hygiene, and the water impermeable material may be cleaned. In some embodiments, the water collection system may be encased in an outer layer. In some embodiments, the outer layer stretches over the water collection system, resulting in a tight-fitting configuration. In some embodiments, the outer layer comprises spandex. In some embodiments, each of the plurality of layer(s) may comprise any combination of the above fabrics or materials.

In some embodiments, the UCS comprises a divider, wherein the UCS is separated from the feces collection system with a divider configured to be adjacent to a user's perineum. The two parts may comprise a rear section, e.g., a feces collection section, and a front section, e.g., a urine collection section, wherein the urine collection section is adapted to fit the needs of the water filtration loop. In some embodiments, the divider comprises a silicone divider. The divider is designed to prevent cross-contamination, which currently contributes to MAG-related health issues. The divider further allows the feces collection system and UCS to be detached from each other in the event of any contamination.

In some embodiments, the water permeable fabric can be formed of a woven fabric. In some embodiments, the woven fabric can be formed by weaving, knitting, crocheting, knotting, tatting, braiding, and combinations thereof. In some embodiments, the water permeable fabric can be formed of a non-woven fabric. In some embodiments, the non-woven fabric can be bonded together by chemical, mechanical, heat, solvent treatment, or combinations thereof. In some embodiments, the water permeable fabric comprises polypropylene. Polypropylene, for example, is permeable and comfortable, and allows urine through while staying dry to prevent irritation. In some embodiments, the water permeable fabric comprises a woven fabric of grade 40 plain unbleached cotton fabric, such as, for example, a polyester microfiber or a nylon-spandex blend. Such a material may allow for the urine to be drawn to an outer surface of the fabric, away from the body, for removal via a vacuum pump connected to the outer surface of the UCS. The antimicrobial material may be configured to safeguard against infection. In some embodiments, the antimicrobial material comprises an antimicrobial polymer (e.g., chitosan, poly-ε-lysine) or an antimicrobial inorganic particle (e.g., silver, copper, titanium dioxide). In some embodiments, the activated carbon (also referred herein as charcoal) is a powder, granulated, pelletized, beaded, impregnated, polymer coated, woven, extruded, and combinations thereof. In some embodiments, the activated carbon may be granulated, formed into sheet, and configured to adsorb impurities (e.g., proteins, peptides, pharmaceuticals, aromatic compounds, hydrocarbons) that may be present in a user's urine. In some embodiments, the second middle layer comprising activated carbon may be sealed to the water impermeable material. In some embodiments, the water impermeable material comprises a molded silicone shell configured to maintain a shape—e.g., a cup shape or the like—or a position relative to the user of the UCS, depending on the user's respective anatomy.

In some embodiments, a portion of any number of the plurality of layers comprises an absorbent hydrogel connected to a passive radio frequency identification (RFID) tag. The hydrogel may comprise a material such that, when the hydrogel absorbs moisture, the RFID tag becomes conductive enough to transmit a signal to an RFID reader so as to activate a separate module, such as, for example, a pumping subsystem (described in more detail below).

In some embodiments, the UCS further comprises a pumping subsystem in contact with the plurality of layers. In some embodiments, the pumping subsystem comprises one or more tubes, each of the one or more tubes comprising a proximal end and a distal end, a pumping device, and a trigger. As a user urinates, the urine may pass through the water-permeable fabric and come into contact with the activated carbon before being drawn into the tubing and eventually a water filter. In some embodiments, each of the one or more tubes comprises one or more of a polyvinyl chloride (PVC) tube and a polyurethane tube. In some embodiments, each of the one or more tubes is flexible. In some embodiments, the contact is achieved by piercing one or more of the plurality of layers with the proximal end of each of the one or more tubes of the pumping subsystem. In some embodiments, the distal end of each of the one or more tubes may conjoin and connect to the pumping device, wherein the pumping device is configured to draw the urine away from the urine collection section toward the filtration system. In some embodiments, the pumping device comprises a centrifugal fan or a pump. In some embodiments, the pumping device is configured apply a vacuum to the conjoined one or more tubes when the trigger is activated. In some embodiments, the trigger is activated by the contact of urine with a sensor. In some embodiments, the sensor is a water sensor, humidity sensor, chemical sensor, temperature sensor, and combinations thereof. If urine is detected by the sensor (e.g., humidity sensor, RFID reader, or the like), urine is pulled through the tubes device and flushed out of the UCS to flow into the filtration system. In some embodiments, the UCS further comprises a button, lever, switch, dial, knob, or selector device (including voice activated or keyed commands) in electrical communication with the trigger, such that if urine is not detected by the trigger, the user may activate the trigger with the button, lever, switch, dial, knob, or selector device (including voice activated or keyed commands). In some embodiments, the pumping subsystem comprises a positive-displacement pump, a centrifugal pump, or an axial-flow pump. In some embodiments, the pumping subsystem comprises a plunger pump (e.g., motor-operated syringe), managed by the electronics module, to pump the urine into the filtration system, such that any lack of gravitational forces would not present additional challenges to urine collection.

In some embodiments, the bodily fluid collection system further comprises a humidity condensate collection subsystem. Current EMUs use a combination of a water-cooling loop and a gas loop. Provided herein is a humidity condensate collection system with fewer components that may yield greater efficiency for water recycling. In some embodiments, the humidity condensate collection subsystem comprises water permeable tubing, a liquid cooling ventilation garment (LCVG), a pump, and an absorber. In some embodiments, the pump is a circulating pump. Exemplary circulating pumps are rotary lobe, rotary gear, progressing cavity, piston, diaphragm, screw, gear, hydraulic, rotary vane, peristaltic, rope, and flexible impeller. In some embodiments, the water permeable tubing is flexible and porous. In some embodiments, the water permeable tubing is Nafion. The water permeable tubing may be attached to the LCVG, wherein the LCVG is adapted to lay across a torso of the user. As the user perspires, their sweat, in gaseous form, may be absorbed into the water permeable tubing due to a concentration gradient formed by an outer and inner surface of the water permeable tubing. The water permeable tubing may be an ion exchange membrane, and thus configured to reject minerals (e.g., sodium, potassium, calcium, and magnesium) as well as metabolites (lactate, ammonia, urea, and uric acid), and partially metabolized or unmetabolized pharmaceuticals that may be present in sweat. All that enters the tubing is liquid water or water vapor, meaning the water permeable tubing serves as an effective filtration system for humidity condensate. While water vapor is absorbed by the water permeable tubing, the salts and other impurities remain in contact with the user's skin and with the outer surface of the tubing. The effects of sweat exposure on the water permeable tubing can be assessed by measuring filtration rate and purity as a function of time when the water permeable tubing is exposed to a user's sweat. The pump may then pump the purified liquid water and/or water vapor to the IDB. In some embodiments, the pump may pump the purified liquid water and/or water vapor to an absorber to condense any water vapor that may be present, generating heat which radiates externally, and further pump the water through polypropylene tubing into the IDB, which joins a water supply by adsorbing to walls of the IDB. In some embodiments, the absorber comprises a lithium chloride absorber/radiator (LCAR), which is an array of porous sponges holding LiCl desiccant in contact with a radiating surface. The humidity condensate collection subsystem therefore may serve to both cool the user through the absorption of latent heat and prevent buildup of condensation within the EMU.

In some embodiments, the bodily fluid collection system further comprises a gas loop. In some embodiments, the gas loop comprises a gas supply, a helmet in fluid communication with the gas supply, a contaminant control cartridge (CCC) in fluid communication with the helmet, a sublimator in fluid communication with the CCC via a centrifugal fan, and a slurper in communication with the sublimator. In some embodiments, the gas supply comprises a primary supply and a redundant supply. The CCC may comprise a gas-trapping material configured to trap exhaled CO₂. In some embodiments, the gas-trapping material is lithium hydroxide. In some embodiments, the CCC contains a filter for trapping particular matter, and an absorbent material for absorbing trace contaminants. In some embodiments, the filter comprises activated carbon or activated charcoal. In some embodiments, when a user exhales, the resulting water vapor is blown by the centrifugal fan through a separate tubing into the sublimator. The sublimator may comprise a gas-passage section comprising a hydrophilic coating on its walls that promote condensation of the water vapor. At a distal end of the gas-passage section is a traverse passage to a slurper where, due to suction created by the centrifugal fan, condensate from the sublimator is drawn by the centrifugal fan. The drawn vapor and condensate enters the slurper into a motor driven rotary water separator, wherein the rotary water separator is managed by the electronics module. The condensate is then pressurized and delivered to the IDB.

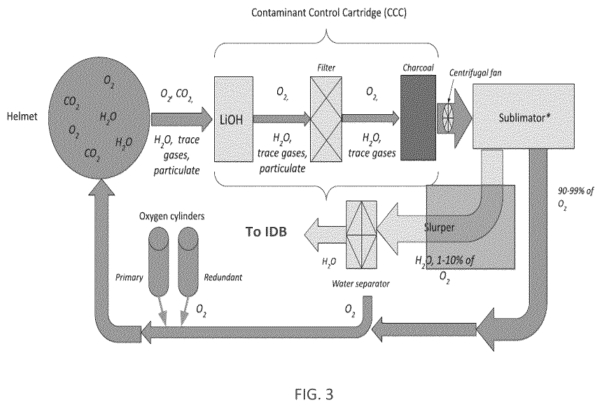

FIG. 3 illustrates an exemplary gas loop, wherein the gas-trapping material comprises lithium hydroxide (LiOH), and the absorbent material comprises charcoal. The gas supply comprises O₂, which flows into the helmet to be inhaled by the user. As the gas flows to the helmet from the gas supply, a significant portion is inhaled, while the remaining O₂, is contaminated by a mix of gases and water vapor exhaled by the user. The mix of gases comprises one or more of CO₂, O₂, trace gases, and particulate matter, each of which is trapped by either the LiOH, the filter, or the charcoal. Here, the primary supply and redundant supply have a pressure of 1380 and 1440 psi, respectively. When integrated into an EMU, the redundant supply may be used when a pressure in the EMU exceeds a pre-determined threshold, such as, for example, 3.7 psi, so as to make up for slower flow of oxygen at lower pressure.

### III. Water Filtration Systems

Current EMUs do not comprise a filtration system, rather they comprise an Alternative Water Processor (AWP). The AWP utilizes a combination of two technologies: a biological water processor that mineralizes organic forms of carbon and nitrogen and an advanced membrane processor, Forward Osmosis Secondary Treatment (FOST), that removes solids and inorganic ions from wastewater. The AWP, however, is designed for recycling large quantities of wastewater from multiple sources (i.e., laundry and fecal matter) that would not have to be incorporated into the water filtration system of an EMU. The biological water processor further uses a series of chemical reactions to pre-treat the water before filtration, which are not conducive to efficiency and sustainability of the water collection and filtration systems disclosed herein.

Provided herein is a water filtration system combining forward and reverse osmosis to conserve energy used by the EMU and filter bodily fluids while eliminating excess use of materials and unnecessary chemical risk. The water filtration systems provided herein are designed to remove urine from the user's genital area, lowering the risk of infection, removing odors, and alleviating skin irritation. The water filtration systems are further designed to recycle the urine produced by the user into potable water, cutting costs and addressing the astronauts' lack of water, a concern that has been raised but never addressed. The water filtration system is configured to capable of at least 75% water recovery from a user's urine, perspiration, and breath, and purity in the resulting drinking water sufficient for a user's consumption, e.g., <250 parts per million (ppm) of NaCl and undetectable concentrations of urine solutes.

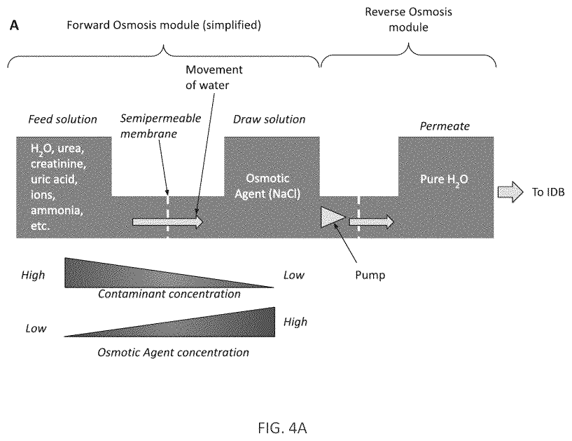

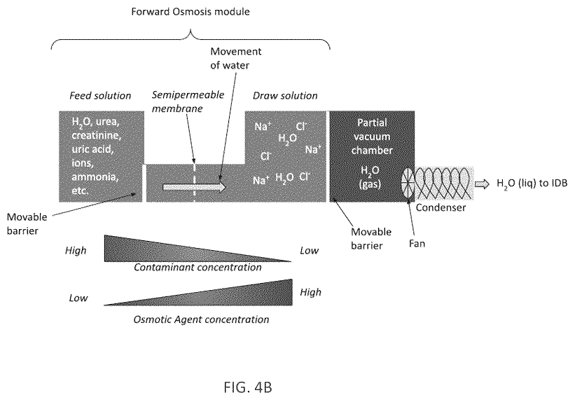

In some embodiments, the water filtration system comprises a forward osmosis (FO) module, a reverse osmosis (RO) module, and a semipermeable membrane, as illustrated in FIGS. 4A-4B. In some embodiments, as illustrated in FIG. 4A, the water filtration system further comprises a pump, and the FO module may be separated into two compartments, a feed solution (FS) compartment and a draw solution (DS) compartment, by the semipermeable membrane. The DS compartment is in fluid communication through the pump with the RO module so as to form a two-step filtration apparatus configured to use (1) a concentration gradient to remove water from urine into a salt solution and (2) a pump to extract treated water from the salt solution. Compared to traditional water filtration with RO, the water filtration system may operate for longer before cleaning and with less energy cost, both of which are crucial in a spacesuit with limited battery capacity, and is likely able to produce a greater yield of potable water than 86.8% from excreted water (v/v). In some embodiments, the pump that feeds fluid from the FO module to the RO module may be further configured to pump permeate up the user's body and into the IDB.

Forward osmosis (FO) is a process where the osmotic potential between two fluids of different solute/solvent concentrations equalize by the movement of solvent (water) from the less concentrated solution—the FS—to the more concentrated DS. In some embodiments, the FS may be urine. In some embodiments, the DS may be a concentrated saline solution. A semipermeable membrane separates the two solutions, which allows only water to diffuse across. The source of the driving force in the FO process is an osmotic pressure difference between the FS and the DS on a permeate side of the membrane. Sodium chloride (NaCl) may be used as the osmotic agent (OA) because of its high solubility and the ease with which it reaches very high osmotic pressures. In some embodiments, the FS may be substituted for a second DS at a higher concentration than the DS.

Reverse osmosis (RO) uses hydraulic pressure to oppose, and exceed, the osmotic pressure of an aqueous FS and produce a permeate solution (PS), e.g., treated water. In some embodiments, hydraulic pressure may be used to remove water from the DS. Thus, in RO, the applied hydraulic pressure may be the driving force for mass transport through the membrane against the osmotic gradient. RO is known for its high efficiency for wastewater treatment, though generally requires high energy consumption. The integration of the RO with FO may reduce energy consumption. First, the FO module filters wastewater using osmotic pressure, then the filtered solution is used as feed for the RO process, removing an osmotic gradient. The use of the FO module to pre-filter the wastewater may help in watery recovery and to reduce the energy required for the RO module as it dilutes the water that must be filtered beforehand. The combination of FO and RO may also allow the draw solution to be concentrated simultaneously as it is diluted by feed solution, thereby maintaining its original concentration. The RO module is also more subject to membrane fouling—i.e., the deposition of particles onto the membrane surface, thereby reducing filtration efficiency—because of the application of external pressure. Finally, the use of the at least two membranes may further increase against solute leakage. Therefore, combining both FO and RO may prolong membrane lifespan.

In some embodiments, as depicted in FIG. 4B, the filtration system comprises an FO module separated into the FS compartment and the DS compartment by the semipermeable membrane. However, instead of the RO module, the filtration system comprises at least one movable barrier, a partial vacuum chamber, a fan, and a condenser. The at least one movable barrier may comprise a first movable barrier positioned between the FS compartment and the semipermeable membrane, of the FO module, and a second movable barrier may be positioned between the DS compartment and the partial vacuum chamber. When the first movable barrier opens, the FS passes through the semipermeable membrane and water enters the draw solution due to the OA. The first movable barrier may then close, and the second movable barrier may open to expose the water and the OA solution to the partial vacuum chamber. The water in the OA solution may then become vapor, and the fan is configured to draw the vapor towards the condenser. In some embodiments, the filtration system further comprises a pump in fluid communication with the condenser, such that condensed vapor may then be pumped to the IDB. In some embodiments, the condenser is the same condenser used in the humidity condensate collection subsystem, thereby consolidating components from different subsystems for multiple functions.

In some embodiments, the filtration system comprises a plurality of feed spacers, optionally wherein the feed spacers are dynamic feed spacers. Feed spacers allow for minimizing of fouling of the semipermeable membrane in the FO module. In some embodiments, the filtration system comprises a turbospacer. The turbospacer may comprise a series of microturbines assembled in ladder type filament cells. The turbospacer is configured to exploit kinetic energy of the flowing FS to rotate the turbines and create high flow turbulence and shear force across the membrane in the FS compartment to prevent the accumulation of foulants on the semi-permeable membrane and related performance decline.

### IV. Cooling Water Loop

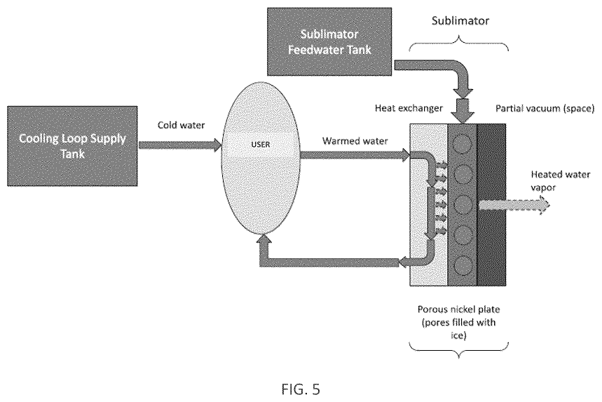

In order to maintain a comfortable core body temperature during EVAs, astronauts commonly wear a liquid cooling and ventilation garment (LCVG) underneath their spacesuits. The LCVG is made of form-fitting spandex fabric and contains a 300-foot network of flexible polyvinyl chloride tubes that enable cool water to circulate in close proximity to the astronaut's skin, regulating their body temperature. The water circulating through the cooling water loop, as illustrated in FIG. 5, is stored in a cooling loop supply tank within the PLSS from which it is pumped through the 300 feet of tubing that encircles the astronaut. As it flows through the LCVG, the circulating water absorbs sensible heat—increasing the temperature of the water—directly from the astronaut; and latent heat when sweat, in the form of water vapor, condenses into liquid on the cool water tubes. The tubes are not permeable, meaning there is no mechanism currently in place to remove perspiration from the astronaut's body, which sometimes leads to unhygienic, uncomfortable, and potentially pathogenic conditions, and necessitates more frequent maintenance of the EMU.

Once heated, the circulating water returns to the PLSS, where it is cooled in a heat exchanger before being recirculated. In the current system, the heat exchange occurs through the use of an ice sublimator: several layers of sintered nickel plates with microscopic pores which are sized to permit the water to freeze within the plate without damaging it. A separate feedwater tank pumps water, with enough pressure to allow it to remain in a liquid state, onto the nickel plate. The plate is partially exposed to the vacuum of space, which has a temperature of 2.7 K and pressure near zero, drastically lowering the temperature and pressure of the plate, and causing the water to freeze. The tubing containing the warmed water from the cooling water loop flows through the sublimator, transferring its heat to the ice. This increase in temperature causes some of the ice to sublimate to water vapor and be released into space, rejecting heat. The chilled circulating water is then pumped back to the LCVG. When there is no need for heat to be removed, new water from the Feedwater Tank refreezes, sealing the plate. The rate of sublimation of the ice is directly proportional to the amount of heat needed to be removed, so the system is self-regulating.

NASA plans to replace the sublimator with a Spacesuit Water Membrane Evaporator (SWME) in future space suits. The SWME exposes the warmed circulating water “directly to ambient vacuum” while passing it through “an array of porous, hydrophobic fibers.” The vacuum causes the vapor pressure outside the hydrophobic fibers to drop below the pressure exerted by water on the inside of the fibers, which rapidly boils some of the water. The resulting water vapor can easily diffuse through the porous fibers, cooling the remaining water. The SWME reduces the temperature drop needed for ultimate heat rejection and solves many practical issues related to sublimator operation such as the accumulation of ‘non-volatile’ contamination in the small (3-6 micrometer) pores from the feedwater tank. The SWME eliminates the need for a separate feedwater tank to supply ice for the sublimator, which aligns with the Center's mission of reducing the weight of water carried within the spacesuit and reducing water waste and cost. However, the SWME's method of water cooling still requires some water to be vented into space, though less than with the current sublimator. Therefore, there is a need for a system of water cooling with zero water vapor loss to space.

Once the ice in the microscopic pores in the sublimator becomes water vapor—due to the transfer of heat from the cooling water loop tubing—it is vented into space, causing a loss of water of a kilo every four hours. The cooling water loop provided herein is configured to allow rerouting of the water vapor produced by exposure to a partial vacuum into a condenser and then feeding that water into the water filtration system and, eventually, the IDB. This requires both the pressure in the sublimating chamber to be higher, so as not to immediately sublimate once heated, and less exposure to space partial vacuum.

Provided herein is a cooling water loop with a dual cooling integrated with the water filtration system. The urine produced by the astronaut is filtered then cooled through a sublimator. The water vapor produced by the melted ice is then pumped throughout the LCVG for latent cooling and the cooled water from the urine is circulated throughout the LCVG for sensible cooling. Both the water vapor from humidity condensate and breath is condensed and passed through the sublimator, such that all produced water vapor is condensed and sent to the IDB while the cooled water serves for cooling. This system further comprises a sublimator feedwater tank. However, the cooling water loop provided herein does not require the 11.5 pounds of water in the cooling water tank, and incurs no loss of water to space vacuum.

### V. Waste Management

The current waste management system on the EMU consists of a MAG which leads to not only discomfort but unhygienic and pathogenic conditions for the crewmember undergoing a spacewalk. Within the helmet, food may be available for astronauts to eat during spacewalks. However, due to strong odors following a bowel movement, many crewmembers report lowered appetite. MAGs need to be removed immediately upon return to the vehicle due to severe skin irritations caused by remaining in contact with urine and feces for up to 8 hours. MAGs can further cause gastrointestinal distress (including gas, bloating, diarrhea, and abdominal pain), UTIs, skin rashes, infections, and eye Irritation. Additionally, if unrecoverable vehicle pressure failure occurs, crewmembers may remain suited for several days without having the capability to access or change their MAGs. There is thus an urgent need for a new waste management system.

In some embodiments, the water and filtration system comprises carbon-sequestering bacteria. In some embodiments, the carbon-sequestering bacteria comprises purple phototrophic bacteria (PPB). PPB are ideal bacterial species for the breakdown of organic waste thanks to their highly diverse metabolism. They can break down organic molecules into carbon and nitrogen gas for use in photosynthesis (instead of CO 2 and H 2 O). In particular, PPB—which can store energy from light—when supplied with an electric current, can recover near to 100% of carbon from any type of organic waste, while generating hydrogen gas for electricity production. These bacteria, if maintained and implemented carefully, allow for the breakdown of waste in the EMU and alleviation of some of the current discomfort and hygiene issues astronauts face. Bacterial breakdown is a slow process usually used for longer-term, larger-scale applications than that within the EMU, such that the PPB may be a significant source of mitigation against the conditions currently faced by astronauts. Bacteria in the EMU, positioned in particular within the water collection system, would have access to urine brine which consists of urea (from amino acid metabolism), inorganic salts, creatinine, ammonia, and pigmented products of blood breakdown such as urochrome as well as feces to thrive off of.

### Illustrative Embodiments

Embodiment 1. A system comprising: a bodily fluid collection system comprising a urine collection system and a feces collection system, the urine collection system comprising: a top layer comprising a water permeable fabric, a first middle layer comprising an antimicrobial material, a second middle layer comprising activated carbon, and a bottom layer comprising a water impermeable material; an osmotic filter configured to filter the collected bodily fluid from the bodily fluid collection system; and a mechanical device configured to move the filtered fluid from the osmotic filter.

Embodiment 2. The system of Embodiment 1, wherein the osmotic filter comprises a forward osmosis module and a reverse osmosis module.

Embodiment 3. The system of any one of Embodiments 1-2, wherein the osmotic filter comprises a forward osmosis module, a vacuum chamber, and a condenser.

Embodiment 4. The system of any one of Embodiments 1-3, wherein the osmotic filter comprises at least one moveable barrier.

Embodiment 5. The system of any one of Embodiments 1-4, wherein the mechanical device is a positive-displacement pump, a centrifugal pump, an axial-flow pump or a centrifugal fan.

Embodiment 6. The system of any one of Embodiments 1-5, wherein the water permeable fabric comprises polypropylene.

Embodiment 7. The system of any one of Embodiments 1-6, wherein the water permeable fabric comprises a non-woven or woven fabric.

Embodiment 8. The system of any one of Embodiments 1-7, wherein the woven fabric is grade 40 plain unbleached cotton.

Embodiment 9. The system of any one of Embodiments 1-8, wherein the activated carbon is a powder, granulated, pelletized, beaded, impregnated, polymer coated, woven, extruded, or combinations thereof.

Embodiment 10. The system of any one of Embodiments 1-9, wherein the activated carbon is granulated.

Embodiment 11. The system of any one of Embodiments 1-10, wherein the antimicrobial material further comprises an antimicrobial polymer or an inorganic particle.

Embodiment 12. The system of any one of Embodiments 1-11, wherein the antimicrobial polymer is chitosan or poly-ε-lysine.

Embodiment 13. The system of any one of Embodiments 1-12, wherein the inorganic particle comprises silver, copper, or titanium dioxide.

Embodiment 14. The system of any one of Embodiments 1-13, wherein the water impermeable material comprises silicone.

Embodiment 15. The system of any one of Embodiments 1—, wherein the urine collection system and the feces collection system are separated by a divider configured to be adjacent to a user's perineum.

Embodiment 16. The system of any one of Embodiments 1-15, wherein the feces collection system further comprises a carbon-sequestering bacteria.

Embodiment 17. The system of any one of Embodiments 1-16, wherein the carbon-sequestering bacteria comprises a purple phototrophic bacteria (PPB).

Embodiment 18. A method comprising: collecting a bodily fluid via a bodily fluid collection system, the bodily fluid collection system comprising: a top layer comprising water permeable fabric, a first middle layer comprising an antimicrobial material, a second middle layer of granular activated carbon, and a bottom layer comprising a water impermeable fabric; filtering, via an osmotic filter, the collected bodily fluid from the bodily fluid collection system; and moving, via a mechanical device, the filtered fluid from the osmotic filter.

Embodiment 19. The method of Embodiment 18, wherein the osmotic filter comprises a forward osmosis filter and a reverse osmosis filter.

Embodiment 20. The method of any one of Embodiments 18-19, wherein the osmotic filter comprises a forward osmosis module, a vacuum chamber, and a condenser.

Embodiment 21. The method of any one of Embodiments 18-20, wherein the osmotic filter comprises at least one moveable barrier.

Embodiment 22. The method of any one of Embodiments 18-21, wherein the mechanical device is a positive-displacement pump, a centrifugal pump, an axial-flow pump. or a centrifugal fan.

Embodiment 23. The method of any one of Embodiments 18-22, wherein the activated carbon is a powder, granulated, pelletized, beaded, impregnated, polymer coated, woven, extruded, or combinations thereof.

Embodiment 24. The method of any one of Embodiments 18-23, wherein the activated carbon is granulated.

Embodiment 25. The method of any one of Embodiments 18-24, wherein the antimicrobial material further comprises an antimicrobial polymer or an inorganic particle.

Embodiment 26. The method of any one of Embodiments 18-25, wherein the antimicrobial polymer is chitosan or poly-ε-lysine.

Embodiment 27. The method of any one of Embodiments 18-26, wherein the inorganic particle comprises silver or copper.

Embodiment 28. The method of any one of Embodiments 18-27, wherein the water impermeable material comprises silicone.

Embodiment 29. A method comprising: filtering and collecting a fluid via at least one semi-permeable tube, wherein the at least one semi-permeable tube is connected to a container; sending, via a mechanical device, the collected fluid from the at least one semi-permeable tube to an absorber radiator; and condensing and absorbing the collected fluid on the absorber radiator, thereby generating heat which radiates to a space outside of the container and the absorber radiator.

Embodiment 30. The method of Embodiment 29, wherein the container is an in-suit drink bag.

Embodiment 31. The method of any one of Embodiments 29-30, wherein the mechanical device is a positive-displacement pump, a centrifugal pump, or an axial-flow pump.

Embodiment 32. The method of any one of Embodiments 29-31, wherein the at least one semi-permeable tube comprises polytetrafluoroethylene.

Embodiment 33. The method of any one of Embodiments 29-32, wherein the absorber radiator is a lithium chloride absorber radiator.

Embodiment 34. A system comprising: a bodily fluid collection system comprising a plurality of layers, wherein the bodily fluid collection system is configured to collect bodily fluid; an osmotic filter configured to process the collected bodily fluid, thereby producing a filtered fluid; a mechanical device configured to move the bodily fluid from the bodily fluid collection system through the osmotic filter; and at least one sensor configured to measure the filtered fluid and/or the collected bodily fluid, wherein the sensor detects and provides an alert if at least one of the following thresholds is exceeded: less than 85% bodily fluid collection rate in the bodily fluid collection system; less than 75% filtered fluid recovery from the osmotic filter; greater than 250 ppm of NaCl in the filtered fluid; or greater than 10 ppm of urine solutes in the filtered fluid.

Embodiment 35. The system of Embodiment 34, wherein the osmotic filter comprises a forward osmosis filter and a reverse osmosis filter.

Embodiment 36. The system of any one of Embodiments 34-35, wherein the osmotic filter comprises a moveable barrier.

Embodiment 37. The system of any one of Embodiments 34-36, wherein the mechanical device is a vacuum pump or a centrifugal fan.

Embodiment 38. The system of any one of Embodiments 34-37, wherein the bodily fluid is urine, and wherein the mechanical device is configured to move the urine from the plurality of layers through the osmotic filter.

Embodiment 39. The system of any one of Embodiments 34-38, wherein the plurality of layers comprises water permeable fabric and/or flexible granular activated carbon.

Embodiment 40. A spacesuit comprising any of the systems of Embodiments 1-17 or 34-39.

Embodiment 41. An extravehicular mobility unit (EMU) comprising any of the systems of Embodiments 1-17 or 34-39.

Embodiment 42. A method comprising: collecting a bodily fluid in a bodily fluid collection system comprising a plurality of layers; filtering the collected bodily fluid with an osmotic filter; analyzing the filtered fluid; and triggering an alert if any one of the following thresholds are exceeded for the filtered fluid: less than 85% bodily fluid collection rate in the bodily fluid collection system; less than 75% filtered fluid recovery from the osmotic filter; greater than 250 ppm of NaCl in the filtered fluid; or greater than 10 ppm of urine solutes in the filtered fluid.

Embodiment 43. The method of Embodiment 42, wherein the bodily fluid is urine.

Embodiment 44. A system comprising: a container configured to hold liquid; at least one semi-permeable tube configured to filter and collect a fluid, wherein the at least one semi-permeable tube is connected to the container; an absorber radiator connected to the at least one semi-permeable tube; and a mechanical device configured to send the collected fluid from the at least one semi-permeable tube to the absorber radiator, wherein the collected fluid condenses and is absorbed, thereby generating heat which radiates to a space outside the system.

Embodiment 45. The system of Embodiment 44, wherein the container comprises an in-suit drink bag and a means of extracting fluid therefrom.

Embodiment 46. The system of any one of Embodiments 44-45, wherein the mechanical device is a circulating pump.

Embodiment 47. The system of any one of Embodiments 44-46, wherein the system comprises a cooling water loop.

Embodiment 48. The system of any one of Embodiments 44-47, wherein the at least one semi-permeable tube comprises polytetrafluoroethylene.

Embodiment 49. The system of any one of Embodiments 44-48, wherein the absorber radiator is a lithium chloride absorber radiator.

### EXAMPLES

### Example 1: Water Collection in Simulated System

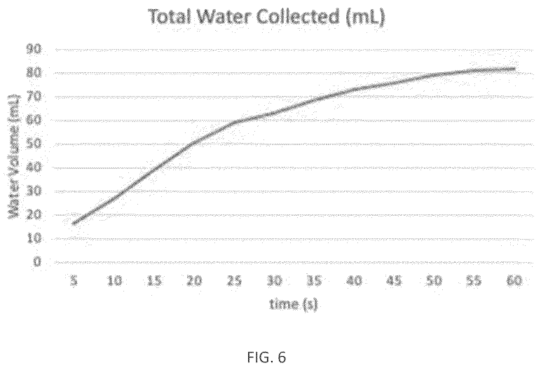

The purpose of this example is to provide results of an exemplary EMU system during a simulated test. FIG. 6 indicates total water collection (mL) over a 1-minute time period using a vacuum pump connected by polyurethane tubing to three layers of water-permeable fabric and a silicone shell. The pump and permeability of the fabrics were tested by using the pump to draw water through the layers of fabric. The modified MAG was placed on top of the water source (a shallow reservoir containing 100 ml of water), leaving several inches of space in between to simulate the low-gravity conditions of space, where water would not naturally flow down through the permeable layers. Mean data for three trials for water collection as a function of time were recorded and are presented in FIG. 6.

While preferred embodiments of the present disclosure have been shown and described herein, it will be obvious to those skilled in the art that such embodiments are provided by way of example only. Numerous variations, changes, and substitutions will now occur to those skilled in the art without departing from the present disclosure. It should be understood that various alternatives to the embodiments described herein, or combinations of one or more of these embodiments or aspects described therein may be employed in practicing the present disclosure. It is intended that the following claims define the scope of the present disclosure and that methods and structures within the scope of these claims and their equivalents be covered thereby.

What is claimed is:

1. A system comprising:
a bodily fluid collection system comprising a urine collection system and a feces collection system, the urine collection system comprising:
a top layer comprising a water permeable fabric;
a first middle layer comprising an antimicrobial material;
a second middle layer comprising activated carbon; and
a bottom layer comprising a water impermeable material;
an osmotic filter configured to filter the collected bodily fluid from the bodily fluid collection system; and
a mechanical device configured to move the filtered fluid from the osmotic filter.

2. The system of claim 1, wherein the osmotic filter comprises a forward osmosis module and a reverse osmosis module.

3. The system of claim 1, wherein the osmotic filter comprises a forward osmosis module, a vacuum chamber, and a condenser.

4. The system of claim 1, wherein the osmotic filter comprises at least one moveable barrier.

5. The system of claim 1, wherein the mechanical device is a positive-displacement pump, a centrifugal pump, an axial-flow pump or a centrifugal fan.

6. The system of claim 1, wherein the water permeable fabric comprises polypropylene.

7. The system of claim 1, wherein the water permeable fabric comprises a non-woven or woven fabric.

8. The system of claim 7, wherein the woven fabric is grade 40 plain unbleached cotton.

9. The system of claim 1, wherein the activated carbon is a powder, granulated, pelletized, beaded, impregnated, polymer coated, woven, extruded, or combinations thereof.

10. The system of claim 1, wherein the activated carbon is granulated.

11. The system of claim 1, wherein the antimicrobial material further comprises an antimicrobial polymer or an inorganic particle.

12. The system of claim 11, wherein the antimicrobial polymer is chitosan or poly-ε-lysine.

13. The system of claim 11, wherein the inorganic particle comprises silver, copper, or titanium dioxide.

14. The system of claim 1, wherein the water impermeable material comprises silicone.

15. The system of claim 1, wherein the urine collection system and the feces collection system are separated by a divider configured to be adjacent to a user's perineum.

16. The system of claim 15, wherein the feces collection system further comprises a carbon-sequestering bacteria.

17. The system of claim 16, wherein the carbon-sequestering bacteria comprises a purple phototrophic bacteria (PPB).

18. A method comprising:
collecting a bodily fluid via a bodily fluid collection system, the bodily fluid collection system comprising:
a top layer comprising water permeable fabric;
a first middle layer comprising an antimicrobial material;
a second middle layer of granular activated carbon; and
a bottom layer comprising a water impermeable fabric;
filtering, via an osmotic filter, the collected bodily fluid from the bodily fluid collection system; and
moving, via a mechanical device, the filtered fluid from the osmotic filter.

19. The method of claim 18, wherein the osmotic filter comprises a forward osmosis filter and a reverse osmosis filter.

20. The method of claim 18, wherein the osmotic filter comprises a forward osmosis module, a vacuum chamber, and a condenser.

21. The method of claim 18, wherein the osmotic filter comprises at least one moveable barrier.

22. The method of claim 18, wherein the mechanical device is a positive-displacement pump, a centrifugal pump, an axial-flow pump. or a centrifugal fan.

23. The method of claim 18, wherein the activated carbon is a powder, granulated, pelletized, beaded, impregnated, polymer coated, woven, extruded, or combinations thereof.

24. The method of claim 18, wherein the activated carbon is granulated.

25. The method of claim 18, wherein the antimicrobial material further comprises an antimicrobial polymer or an inorganic particle.

26. The method of claim 18, wherein the antimicrobial polymer is chitosan or poly-ε-lysine.

27. The method of claim 18, wherein the inorganic particle comprises silver or copper.

28. The method of claim 18, wherein the water impermeable material comprises silicone.
